(19) United States
(12) Patent Application Publication
(10) Pub. No.: US 2009/0199111 A1
(43) Pub. Date: Aug. 6, 2009

(54) CHAT SOFTWARE

(75) Inventors: Terumi Emori, Tokyo (JP); Jiro Tsubakihara, Tokyo (JP); Yoshitaka Suzuki, Tokyo (JP)

Correspondence Address: MCCORMICK, PAULDING & HUBER LLP, CITY PLACE II, 185 ASYLUM STREET, HARTFORD, CT, 06103, US

(73) Assignee: G-mode Co., Ltd., Tokyo (JP)

(21) Appl. No.: 12/357,613

(22) Filed: Jan. 22, 2009

(30) Foreign Application Priority Data
Jan. 31, 2008 (JP) 2008-21509

(51) Int. Cl. G06F 3/00

(52) U.S. Cl. 715/758

(57) ABSTRACT

Provided is a display method for visually distinguishing an avatar which speaks actively from another avatar which does not speak so actively. A server scores each avatar depending on whether messages are old or new and on frequency to speak, and sends the score to terminals. The terminal which received the score sent from the server arranges an avatar with a higher score at a position easily seen by an operator of the terminal, so that the operator understands the ranking of the avatars at a glance.

### CROSS-REFERENCE TO RELATED APPLICATION

The present application claims priority from Japanese Patent Application No. JP 2008-021509 filed on Jan. 31, 2008, the content of which is hereby incorporated by reference into this application.

### TECHNICAL FIELD OF THE INVENTION

The present invention relates to a method of displaying group chat software in which concurrent access of two or more participants is possible. More particularly, the present invention relates to a method of displaying text data inputted by participants' terminals.

### BACKGROUND OF THE INVENTION

Chat software for exchanging information (mainly text information) among a plurality of terminals via a server etc. located on network has been accepted as a general service. In implementation of installation of chat software, the chat service is not only implemented by itself, but also is implemented, in many cases, in the form of accompanying other services which can gather a large number of customers, such as an MMORPG (Massively Multiplayer Online Role-Playing Game) and a moving picture service.

The chat software desirably displays participants' messages in a manner that can be intuitively understood. The chat software which displays only texts generally arranges the texts in order of messages and displays the messages by scrolling. However, in order to provide more entertaining nature, a method of displaying texts using speech balloons as if avatars are speaking the text contents has been also used.

In implementation of the chat software in the form accompanying other services as mentioned above, because of the ability to attract a large number of customers, new problems which cannot be dealt with in the conventional chat software often arise. The following are prior arts of such a method of intuitively displaying by avatars.

Japanese Patent Application Laid-Open Publication No. 2001-351125 (Patent Document 1) discloses a method of determining an order of priority of messages of a plurality of avatars to move a speech balloon of the message with lower priority. The priority is determined by the order the messages are sent.

Also, Japanese Patent Application Laid-Open Publication No. 2002-183762 (Patent Document 2) discloses a method of preventing overlaps of characters (equivalent to “avatars” in the present specification) and messages by limiting the number of characters to be displayed simultaneously to prevent lowering of processing speed.

### SUMMARY OF THE INVENTION

However, although the method disclosed in Patent Document 1 poses no problem in implementation with only chat software, a large limitation is imposed depending on the number of participants. That is, when a large number of avatars and a plurality of speech balloons are present, finding positions to which the speech balloons are moved is difficult.

Besides, the method disclosed in Patent Document 2 limits objects to be displayed only to those objects having a specific relation with operators, and therefore, it lacks a perspective on how to handle messages given by other characters which are not displayed.

It is an object of the present invention to provide a display method for visually distinguishing avatars of operators who actively speaks from avatars of operators who do not very actively speak.

The above and other objects and novel characteristics of the present invention will be apparent from the description of the present specification and the accompanying drawings.

The typical ones of the inventions disclosed in the present application will be briefly described as follows.

Chat software according to a typical embodiment of the present invention comprises a display module and an arithmetic module, in which a participant in a chat room established by a server connected via a communication module is displayed as an avatar, where the communication module receives a score sent by the server and the arithmetic module determines a display position of the participant in the chat room based on the score received by the communication module, and the display module outputs the avatar to a display device connected to a terminal based on the display position.

The chat software can have a feature such that, when chat data including a user ID of a speaker and text data of a message is sent from the server, the communication module receives the chat data and the arithmetic module creates a speech balloon object including information on the display position, the user ID of the chat data, and a speech balloon priority for determining an order among a plurality of speech balloons with the chat data received by the communication module, and the display module outputs a speech balloon of the speech balloon object to the display device connected to the terminal based on the information on the display position stored in the speech balloon object.

The chat software can have a feature such that, when a plurality of speech balloon objects are present, the arithmetic module performs collision judgment of the speech balloons and updates the information on the display positions stored in the plurality of speech balloon objects, and the display module outputs the speech balloons of the plurality of speech balloon objects to the display device connected to the terminal based on the information on the display positions after update.

The chat software can have a feature such that, when a plurality of speech balloon objects exist, the arithmetic module updates only the information on the display position of the speech balloon object with a lower speech balloon priority when performing the collision judgment among the speech balloons.

The chat software can have a feature such that a speech balloon object having a smaller value of the speech balloon priority has a higher speech balloon priority.

The chat software can have a feature such that the arithmetic module increments the value of the speech balloon priority of the existing speech balloon object by one when the communication module received the chat data.

The chat software can have a feature such that a speech balloon object having a greater value of the speech balloon priority has a higher speech balloon priority, where the arithmetic module decrements the value of the speech balloon priority of an existing speech balloon object by one when the communication module received the chat data.

Chat software according to a typical embodiment of the present invention comprises a display module and an arithmetic module, in which a participant in a chat room established by a server connected via a communication module is displayed as an avatar, and a current display position and a target position after movement of the avatar are managed by an avatar object corresponding to the avatar, where the communication module receives a score sent by the server, and the arithmetic module determines the target position after movement of the avatar of the participant in the chat room based on the score received by the communication module and records the target position after movement determined for the avatar object corresponding to the avatar, and, when the current display position and the target position after movement of the avatar object corresponding to the avatar are different, the arithmetic module calculates an updated display position and records the calculated updated display position as a current display position of the corresponding avatar object, and the display module outputs the avatar to the connected display device based on the updated display position.

The chat software can have a feature such that, when chat data including a user ID of a speaker and text data of a message are sent from the server, the communication module receives the chat data and the arithmetic module creates a speech balloon object including information on the display position, the user ID of the chat data, and a speech balloon priority for determining an order among a plurality of speech balloons with the chat data received by the communication module, and the display module outputs a speech balloon relating to the speech balloon object to the display device based on the information on the display position stored in the speech balloon object.

The chat software can have a feature such that the avatar object further stores the user ID and the user ID of the speech balloon object and the user ID of the avatar object are compared, and when the user ID of the speech balloon object is the same as the user ID of the avatar object, the arithmetic module creates drawing data for a speech balloon line for drawing a line for a speech balloon between the avatar corresponding to the avatar object and the speech balloon corresponding to the speech balloon object, then the arithmetic module sends the drawing data for the speech balloon line to the display module, and the display module outputs the line for the speech balloon to the connected display device based on the drawing data for the speech balloon line.

The effects obtained by typical aspects of the present invention will be briefly described below.

In a display method of chat software according to a typical embodiment of the present invention, an avatar which speaks more actively than others can occupy a more noticeable position on a screen so that a speaker (meaning a user who operates the avatar herein) who is interested in a current subject can be intelligibly displayed.

In a display method of chat software according to a typical embodiment of the present invention, when an avatar is moved, a relation such as ranking with other avatars having been presented thus far is generated. Therefore, an effect to encourage participants to speak can be expected. Consequently, more active chat can be expected.

### BRIEF DESCRIPTIONS OF THE DRAWINGS

FIG. 1 is a conceptual diagram showing a hardware environment according to the present invention;

FIG. 2 is a schematic diagram showing a configuration of each terminal according to the present invention;

FIG. 3 is a diagram showing arrangement of avatars on a display screen according to the present invention;

FIG. 4 is a schematic diagram showing a configuration of a server;

FIG. 5 is a sequence chart for a terminal to join in a chat room established by the server;

FIG. 6 is a sequence chart for an operator of the terminal who has joined in the chat room to speak in the chat room;

FIG. 7 is a conceptual description showing a data configuration of chat data to be sent;

FIG. 8 is a flow chart for counting scores at the server;

FIG. 9 is a conceptual description showing a data configuration of a message log;

FIG. 10 is a flow chart showing a rearrangement after a terminal received a score according to a first embodiment;

FIG. 11 is a diagram showing an example of arrangement priorities at an avatar arrangement area;

FIG. 12 is a diagram showing another example of the arrangement priorities at the avatar arrangement area;

FIG. 13 is a diagram showing how to determine the priorities when an odd number of avatars are displayed in the case of FIG. 12;

FIG. 14 is a diagram showing an example of rearrangement of the avatars when an avatar with a lower arrangement priority speaks in the case of FIG. 12;

FIG. 15 is a flow chart showing a process to create a speech balloon;

FIG. 16 is a conceptual description showing a data configuration of a speech balloon object;

FIG. 17 is a flow chart showing a collision judgment process;

FIG. 18 is a conceptual diagram for understanding a step S352;

FIG. 19 is a flow chart according to a third embodiment (in changing appearance of an avatar);

FIG. 20 is a conceptual description showing a data configuration of an object for managing avatar in the XML format according to a fourth embodiment; and

FIG. 21 is a flowchart showing an example of rearrangement of arrangement priorities at an avatar arrangement area according to the fourth embodiment.

### DESCRIPTIONS OF THE PREFERRED EMBODIMENTS

Hereinafter, embodiments according to the present invention will be described with reference to the attached drawings.

### First Embodiment

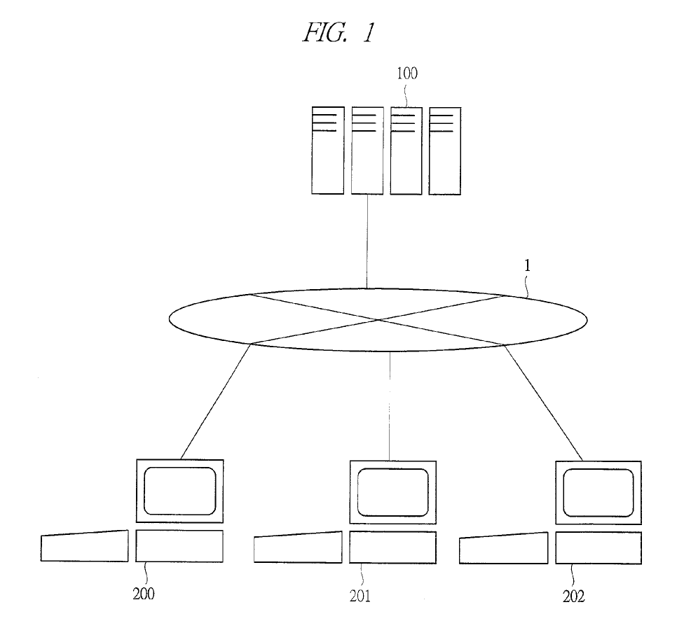

FIG. 1 is a conceptual diagram showing a hardware environment used in this embodiment.

A server 100 is connected to a terminal 200 via a network 1 in the present invention. Other terminals 201 and 202 are also connected to the network 1 in addition to the terminal 200 and use the same server 100.

The network 1 is mainly assumed to be the Internet, but not limited to this in the present invention. A network in a closed environment owned by a specific company, such as a mobile phone service, can be used as long as terminals can be directly or indirectly connected to the server 100.

The server 100 is a server for providing a so-called chat room to the terminals 200 to 202.

The terminals 200 to 202 are terminals operated by users (hereinafter, referred to as operators) using the chat room. These terminals have a display device and an input device. The terminals are connected to the network 1 and can use the chat room provided by the server 100 via the network 1.

Since hardware configurations of the server 100 and the terminals 200 to 202 are not specialized for the present invention, descriptions thereof are omitted herein.

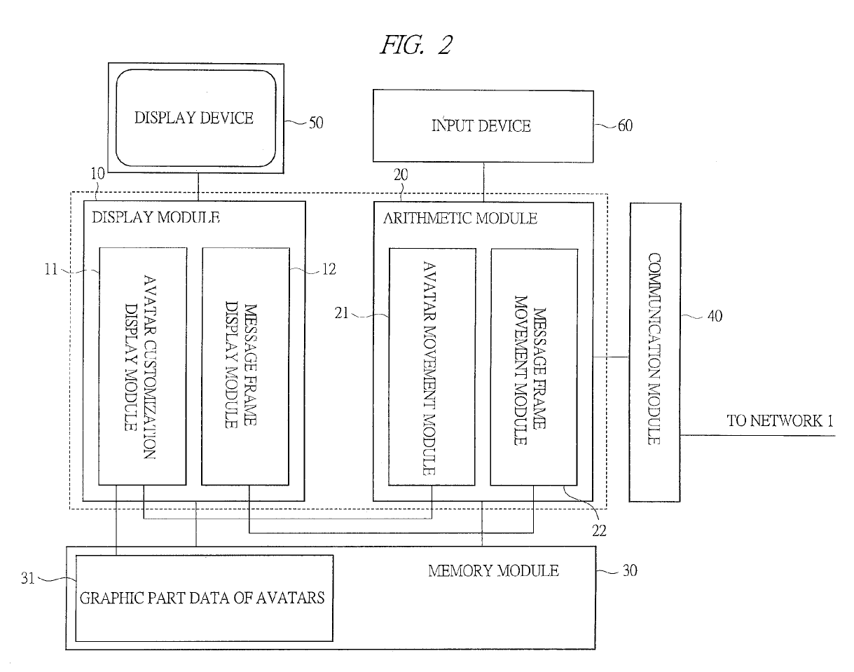

FIG. 2 is a schematic diagram showing a configuration of each terminal.

Each terminal mainly includes a display module 10, an arithmetic module 20, a memory module 30, a communication module 40, a display device 50, and an input device 60.

The display module 10 and the arithmetic module 20 according to the present invention are software modules (chat software) premised to be processed mainly by a CPU (central processing unit) of the terminal. On the other hand, the memory module 30 and the communication module 40 are modules including hardware and firmware for driving the hardware. The display device 50 and the input device 60 are hardware.

The display module 10 further includes an avatar customization display module 11 and a message frame display module 12. When other application software are working in cooperation or operating simultaneously, an OS (operating system) of the terminal synthesizes image data, and the display module 10 generates and displays the data to be synthesized in this process.

The avatar customization display module 11 is a software module for creating graphical data to display on the display device 50 from character data (graphic part data 31 of the avatar to be mentioned later) about the avatar's appearance etc. The avatar synthesized at the avatar customization display module 11 relates to avatars not only an operator's avatar, but also other avatars in the same chat room.

The message frame display module 12 creates a message frame (so-called speech balloon; hereinafter, the message frame and the speech balloon indicate the same object) based on text data included in chat data sent from the network 1. The message frame display module 12 also displays texts of the text data inputted to the created message frame. Creation of the message frame and display of the texts is performed not only for the operator's avatar, but also for other avatars in the same chat room.

Furthermore, the message frame display module 12 refers to the user ID included in the chat data and draws a “speech balloon line” between the message frame and the corresponding avatar. The message frame display module 12 also performs redraw of the speech balloon line when the avatar is moved.

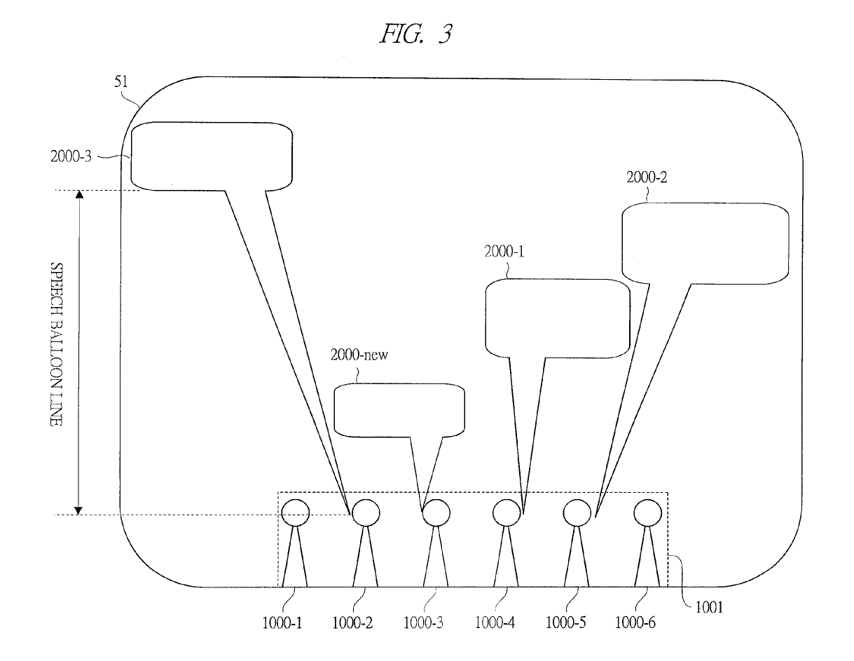

The display module 10 synthesizes outputs of the avatar customization display modules 11 and the message frame display module 12 and outputs a chat screen to the display device 50. FIG. 3 shows an output in this process.

In FIG. 3, avatars 1000-1 to 1000-6, speech balloons 2000-1 to 2000-3 and 2000-new are displayed on a screen 51 of the display device 50. In the present embodiment, the avatars 1000-1 to 1000-6 are aligned at an avatar arrangement area 1001.

Each avatar 1000 is a character representing an avatar as “representation” of an operator of each terminal. Each avatar 1000 has an appearance comprising character data such as a shape of face, hairstyle, and clothing. The operator of each terminal can also change the appearance of the avatar 1000 which he or she operates one after another.

The avatar arrangement area 1001 is an area provided at a lower part of the screen 51 to arrange the avatars 1000. Although FIG. 3 shows the avatar arrangement area 1001 by one layer, two or more layers may be used when the number of participants in the chat room increases.

Each speech balloon 2000 is a display area for displaying the texts of the chat data sent from each terminal. Although the texts are not shown in the figure for the sake of simplicity, the texts are displayed in the speech balloons in practice. The speech balloon 2000 is generated in the vicinity of the avatar arrangement area 1001 every time new chat data is inputted. Collision detection between a newly generated speech balloon 2000 (the newest speech balloon will be, hereafter, referred to as the speech balloon 2000-new) and existing speech balloons 2000 is performed to move the existing speech balloons 2000 to the upper part of the screen 51 in order to provide a chat screen which can be intuitively understood.

Although the speech balloons 2000 are rounded rectangles in the figure, other shapes such as an ellipse may also be used.

The rest of the area on the screen 51 may display information about other services.

FIG. 2 will now be described again.

The arithmetic module 20 is a module for performing various kinds of input processes and arithmetic processes. The arithmetic module 20 includes an avatar movement module 21 and a message frame movement module 22.

The avatar movement module 21 is a module for determining which avatar is arranged to which position at the lower part of the screen in FIG. 3. The avatar movement module 21 determines the arrangement priority of the avatars based on the scores sent from the server 100. Details thereof will be described later.

The message frame movement module 22 is a module for moving the message frames and the texts displayed in the message frames based on an input of the texts or elapsed time. For management of the message frames, the message frame movement module 22 generates speech balloon objects (FIG. 16) to be mentioned later and manages the message frames based the generated speech balloon objects.

The memory module 30 is a module including hardware and firmware for constantly or temporarily storing data used by the display module 10 and the arithmetic module 20. In the present embodiment, the graphic part data 31 etc. for the avatars used by the avatar customization display module 11 is stored.

The communication module 40 is a module including hardware and firmware for performing transmission and reception of chat data between the server 100 via the network 1.

The display device 50 is an output device for outputting image data outputted by the display module 10 and other application software.

The input device 60 is a keyboard, a voice input unit, etc. for the operator of the terminal to input text data for the chat.

Next, a configuration of the server 100 for providing the chat room will be described.

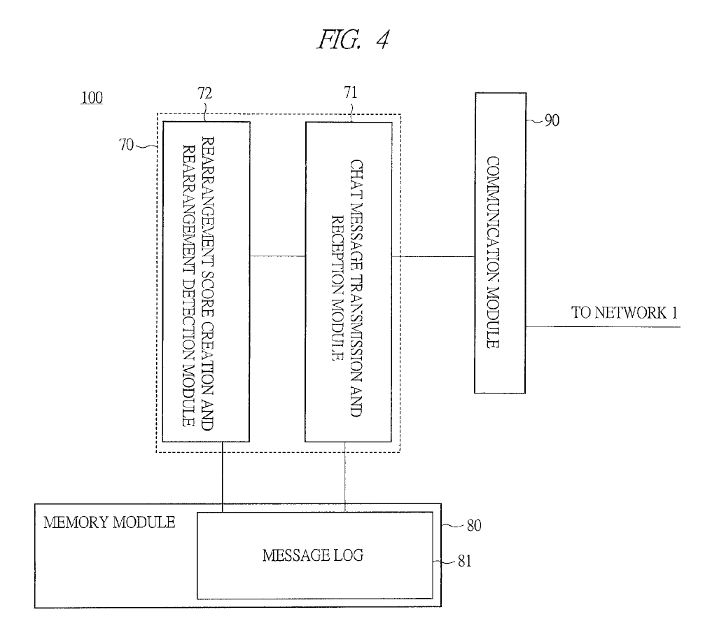

FIG. 4 is a schematic diagram showing the configuration of the server 100.

The server 100 mainly includes chat server software 70, a memory module 80, and a communication module 90.

The chat server software 70 is server-side software to manage the chat room. As mentioned above, although the terminals need the graphic part data 31 etc. for the avatars, the chat server software 70 described herein does not take distribution thereof into consideration in order to limit descriptions only to functionalities. Whether or not such functionality is implemented depends on design.

The chat server software 70 includes a chat message transmission and reception module 71 and a rearrangement score creation and rearrangement detection module 72.

The chat message transmission and reception module 71 is a module for receiving the chat data sent from the terminal 200 and sending a rearrangement score generated by the rearrangement score creation and rearrangement detection module 72 and the chat data to be delivered to each terminal. Also included are: an authentication module for authentication such as for determining whether an entrance to the chat rooms is approved; a management function for the chat room, which is a basic functionality of the chat server software (management of a single or a plurality of chat rooms); and a module for re-sending the chat data from the operator in the chat room, but these are common modules and thus descriptions thereof will be omitted.

The memory module 80 stores the chat data sent from the terminals 200 to 202 and the scores created by the rearrangement score creation and rearrangement detection module 72. In addition, the memory module 80 stores a message log 81 which is referred when the rearrangement score creation and rearrangement detection module 72 creates the scores.

The message log 81 is a log of data outputted and inputted by the chat message transmission and reception module 71.

The communication module 90 is a module including hardware and firmware for performing transmission and reception of the chat data with the terminals 200 to 202 via the network 1.

The chat data are exchanged between the server 100 and the terminals 200 to 202 to build a chat environment.

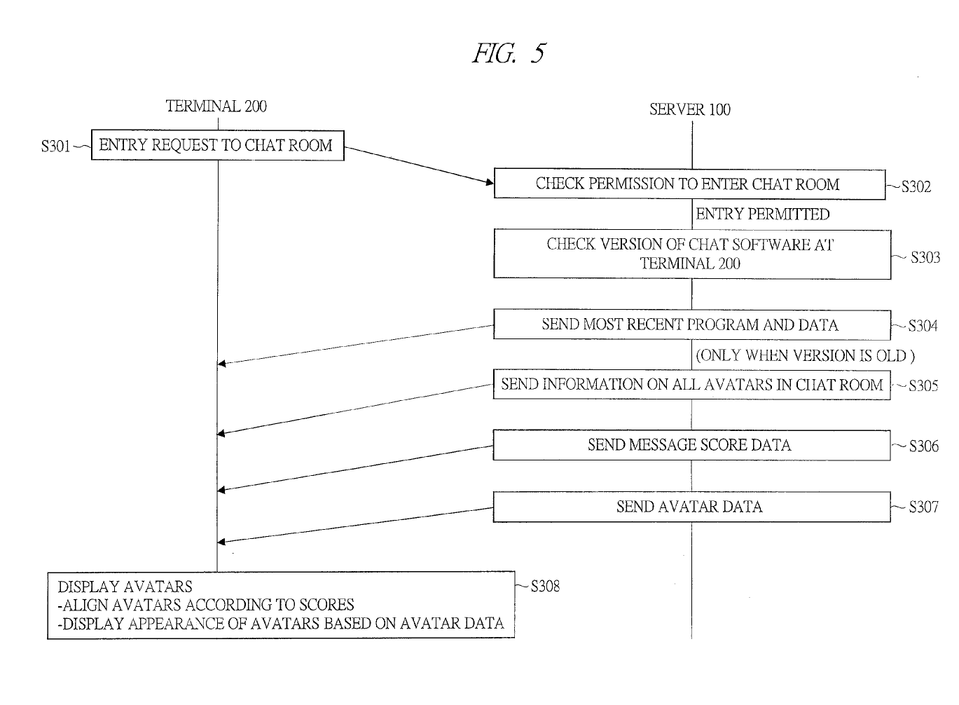

Next, a process for the avatar operated by the operator at the terminal 200 to enter or leave the chat room established by the server 100 will be described with reference to FIG. 5. In FIG. 5, the terminal 200 is assumed to participate in the chat room.

FIG. 5 is a sequence chart for the terminal 200 to join in the chat room established by the server 100.

The operator of the terminal 200 who wants to join in the chat room established by the server 100 starts the chat software and issues a request to enter the chat room to the server 100 (step S301). In this step, version information etc. of the chat software running in the terminal 200 is also sent.

The server 100 receives the request to enter the chat room and checks permission to enter the room (step S302). In this process, only general processes such as checks for payment for service by the operator of the terminal are performed, and therefore, details are omitted.

When the entrance to the chat room is permitted, the server 100 checks whether the chat software is the most recent version from the version information of the chat software sent at the step S301 (step S303). If the chat software is not the most recent version, the server 100 sends the most recent program and data to the terminal 200 (step S304). Thereby, problems caused by version differences between the terminals will be solved.

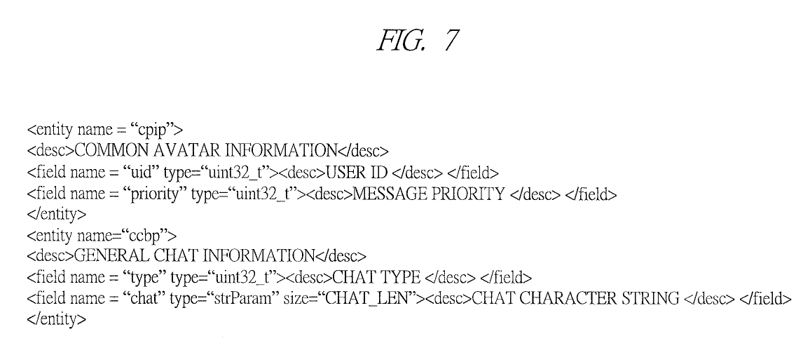

Next, regardless of old or new of the version, the server 100 sends common avatar information of current participants in the chat room into which the terminal 200 is entering to the terminal 200 (step S305). The common avatar information is recorded on the memory module 30 by the arithmetic module 20. The arithmetic module 20 distinguishes whether a speaker is a manager or not using the common avatar information. Since the common avatar information mentioned here is identical to the common avatar information of FIG. 7, a configuration therefor will be described later.

The rearrangement score creation and rearrangement detection module 72 in the server 100 sends the existing scores indicating the display order of the avatars to the terminal 200 (step S306). The terminal 200 determines the order to display the avatars 1000 based on the scores sent in this process.

Furthermore, the rearrangement score creation and rearrangement detection module 72 at the server 100 sends data to be used to define the appearance etc. of the avatars currently joining in the chat room to the terminal 200 (step S307). With this, the avatar customization display module 11 at the terminal 200 creates display data of each avatar to display.

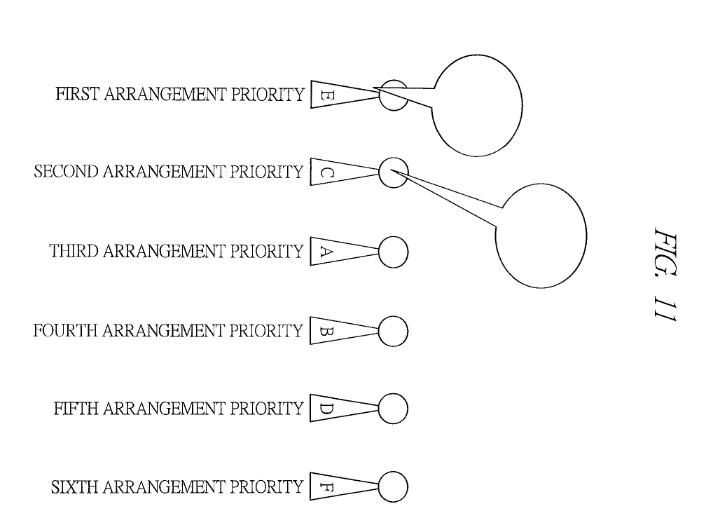

Subsequently, the terminal 200 displays the avatar 1000 using the created display position and display data (step S308). This completes the joining process to the chat room. Detailed display processes such as the order for display will become apparent from FIG. 10 and descriptions therefor.

Note that, the check of the version information at the step S303 and the update process to the latest version of the program and data at the step S304 may be performed not upon joining the chat room, but upon starting the chat software, so that the consistency of the programs and data is maintained.

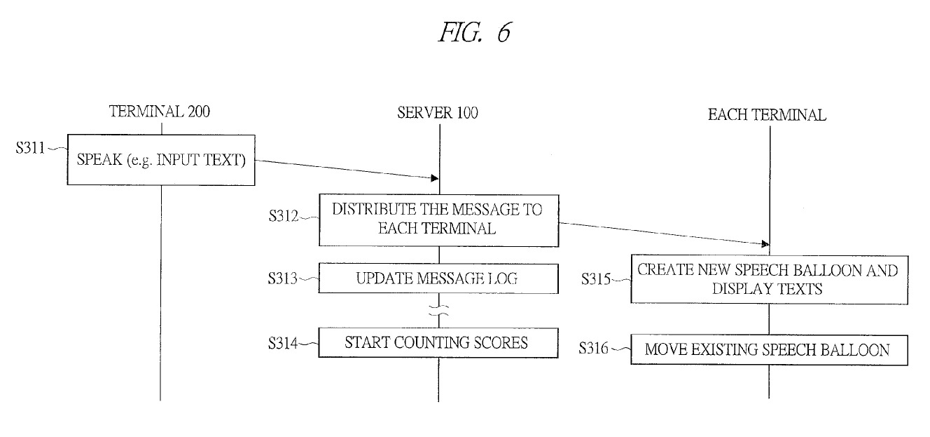

Next, a process of processing the messages by the operator of the terminal 200 after joining the chat room will be described with reference to FIG. 6. FIG. 6 is a sequence chart for the operator of the terminal 200 who has joined in the chat room to speak. “EACH TERMINAL” in FIG. 6 means the terminals including the terminal 200 used by the speakers joining in the chat room.

First, the operator of the terminal 200 uses the input device 60 to input texts for chat data and sends the chat data to the server 100 (step S311).

Note that, FIG. 7 is a conceptual description showing a data configuration of the chat data sent at the step S311. The chat data includes two types of information of the common avatar information indicating an attribute of the avatar as a speaker and general chat information indicating an attribute of the chat data.

The common avatar information includes a user ID and a message priority. The common avatar information is identical to the one sent at the step S305.

The user ID is a parameter indicating the user ID owned by the avatar as a speaker. In addition, the message priority is a parameter indicating a special priority for identifying the case where the avatar is used by a manager etc. and is given a higher priority than the other participants in the chat room.

The general chat information includes a chat type and a chat character string. The chat character string is sample data which may be changed depending on the type of data to be sent.

The chat type is a parameter indicating the type of data included in the chat data.

The chat character string is a parameter (data entity) indicating a character string itself attached to the chat data. Data type (type) and data length (size) of the data are also specified as subparameters.

The chat data is sent from the terminal 200 to the server 100 in such a style described above.

The chat message transmission and reception module 71 in the server 100 which have received the chat data properly transmits the received chat data to each terminal joining in the chat room (step S312). In this process, whether the chat message transmission and reception module 71 uses multicast communication or individual transmission as a transfer method depends on design. In addition, a decision not to re-send may be made with a filter for contents of messages etc. In addition, chat data with no text by deleting data or chat data including screened letters may also be sent.

The chat message transmission and reception module 71 updates the message log 81 as to the re-sent chat data (step S313). Thereby, the priority of each avatar written in the message log 81 will be possibly changed. The rearrangement score creation and rearrangement detection module 72 detects update of the message log 81 periodically or with a software interrupt and recounts the scores (step S314). The timing for recounting the scores mentioned above is provided only as an example and depends on design.

On the other hand, each terminal which received the transmitted chat data creates the speech balloon 2000-new for message data and displays texts of the chat data in the speech balloon 2000-new (step S315). At the same time, each existing speech balloon is moved as if it is pushed out by the newly created speech balloon 2000-new (step S316). Details of the movement will be described later.

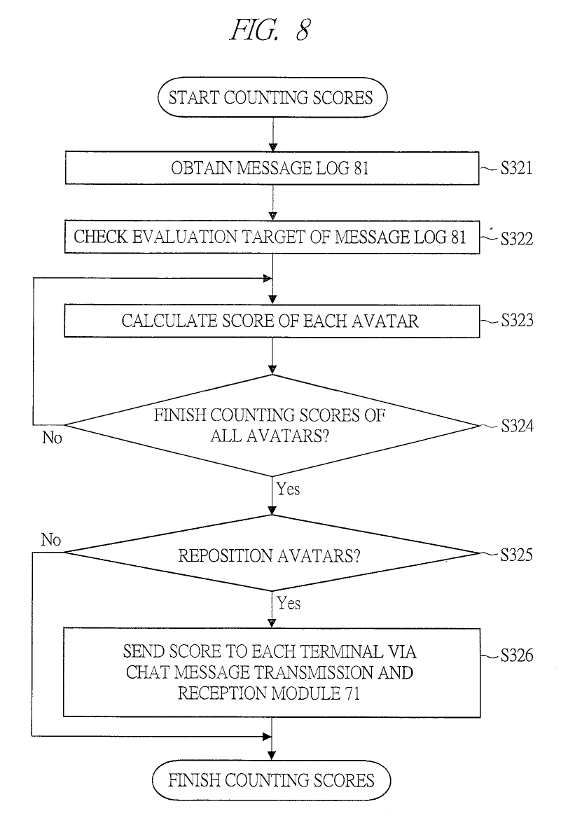

Next, counting of the score at the step S314 will be described in detail with reference to FIG. 8.

FIG. 8 is a flow chart regarding counting of the scores.

First, the trigger to start counting the score could be the update of the message log 81 at the step S313 or a timer interrupt performed at a constant cycle. When a start condition of counting the scores is satisfied, the rearrangement score creation and rearrangement detection module 72 obtains the message log 81 to use as a target for counting the scores (step S321).

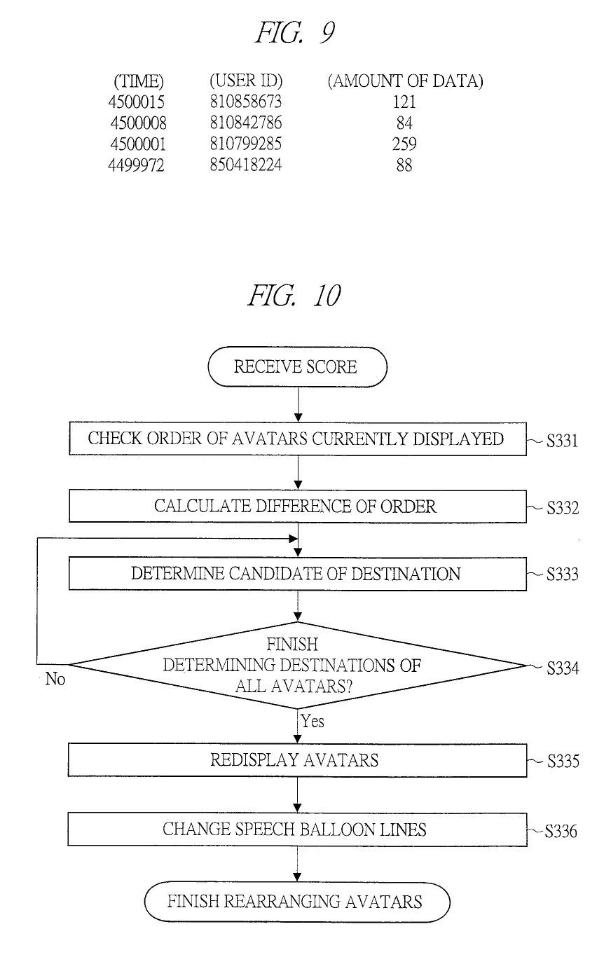

FIG. 9 is a conceptual description showing a data configuration of the message log 81 read at the step S321. Each entry (tuple) of the message log 81 consists of three attributes of time, user ID, and amount of data.

The time indicates the time when the chat data sent from the terminal was resent. The time may be the standard time used by people or the relative time after the server software 70 was activated on the server. The relative time is used herein.

The user ID is an operator's user ID stored in the chat software as a speaker on the terminal. As mentioned above, the user ID of the chat data sent from the terminal is extracted at the step S311 to be stored in this attribute.

The amount of data is an attribute to store the data length of the transmitted chat data. The data entity itself of the chat data as well as the data length may be also stored.

FIG. 8 will now be described again.

Subsequently, an evaluation target item is specified in the obtained message log 81 (step S322). The evaluation target in the present embodiment means each tuple in the message log 81 written in a certain period of time before the evaluation point of time. The items in the log not included in the evaluation target here will not be treated as evaluation targets below.

When the evaluation target item is specified, the rearrangement score creation and rearrangement detection module 72 calculates the score of each avatar currently present in the chat room (step S323). In this process, the rearrangement score creation and rearrangement detection module 72 specifies the avatars with the user IDs shown in FIG. 9.

In time of calculating the score of the message log 81, a tuple with a later reception time is given a higher point and a tuple with older reception time is given a lower point. Then, the point assigned to each tuple is accumulated for each avatar to count the score per avatar. The point assigned to each tuple depends on design.

When counting the scores of all the avatars is finished (step S324: Yes), the scores of respective avatars are compared to determine the priority among the avatars (step S325). When the priority among the avatars before counting and the priority among the avatars after counting have any difference, repositioning of the avatars occurs (step S325: Yes), and the rearrangement score creation and rearrangement detection module 72 sends the score to each terminal via the chat message transmission and reception module 71 (step S326).

Although the scores of all the avatars in the chat room are sent at the step S326 herein, only the order regarding rank of the avatars may be sent.

Each terminal changes the order of the avatars arranged at the avatar arrangement area 1001 by receiving the score sent in this process.

Next, a rearrangement process performed at the terminal which received the score will be described with reference to the drawings.

As shown in FIG. 3, each terminal displays the avatars in the chat room at the avatar arrangement area 1001. Processes at the avatar movement module 21 of the terminal which received the score sent at the step S326 shown in FIG. 8 will be mainly described now.

FIG. 10 is a flow chart showing the rearrangement of the avatars after receiving the scores.

First, when the avatar movement module 21 receives the score via the communication module 40, the avatar movement module 21 checks the order of arrangement of the avatars currently displayed (step S331). Then, the avatar movement module 21 compares the order with the priority of the received scores to check changes (step S332).

After checking the changes, the avatars to be changed and the destinations of the priority changes in the received scores are checked (step S333). A process to determine the destinations will now be described.

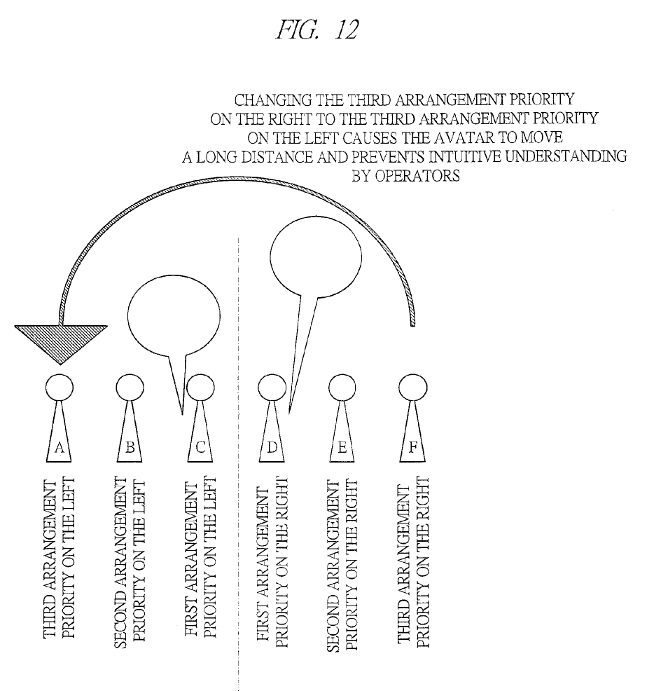

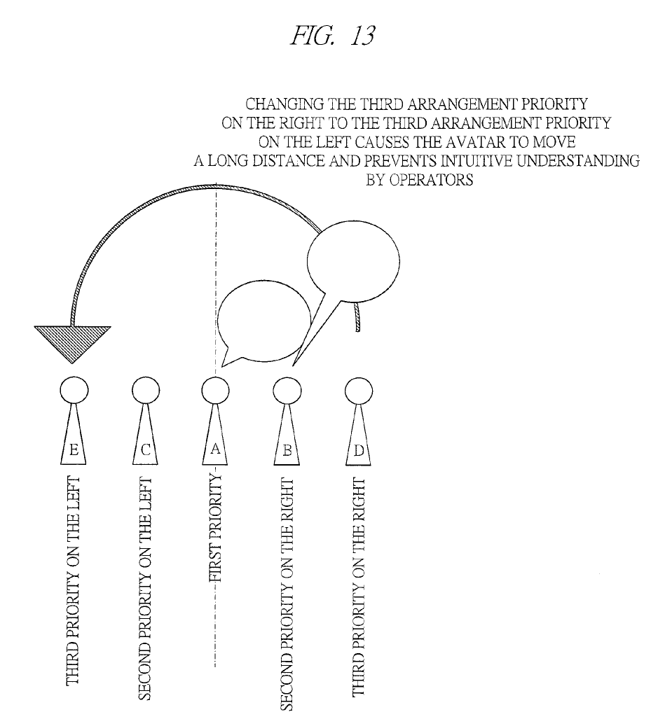

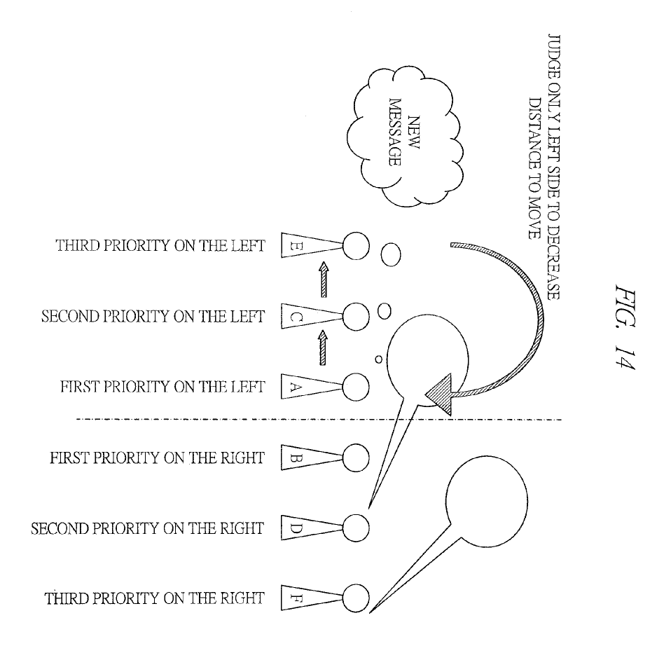

FIGS. 11 and 12 show examples of the arrangement priorities at the avatar arrangement area. FIG. 13 shows how to determine the priorities when an odd number of avatars are displayed in the case of FIG. 12. FIG. 14 shows an example of rearrangement of the avatars when an avatar with a lower arrangement priority speaks in the case of FIG. 12.

When the avatars are linearly arranged with positioning the highest arrangement priority at the left end (or right end) as shown in FIG. 11, the order does not need to be given any consideration in particular.

However, when the center of the avatar arrangement area 1001 is given the highest arrangement priority as shown in FIG. 12 and FIG. 13, the process will be more complicated. In FIG. 12 and FIG. 13, the first arrangement priority has a higher priority than the second and lower arrangement priorities regardless of whether an avatar is located on the right or on the left, and when the arrangement priorities are the same, the one on the right is given a higher priority.

In this case, the following problem is posed. When the priority of another avatar is increased, the third arrangement priority on the right could be changed to the third arrangement priority on the left. When this change is applied, the avatar is moved from the right end to the left end on the screen, preventing intuitive understanding by operators.

However, once the avatars are arranged on the right or left, easy intuition understanding by the operator can be maintained by judging only either on the right or on the left regardless of the priority of the score.

In addition, although effects are limited since the first priority on the left and the first priority on the right are adjacent to each other, judgment only with the arrangement priority on the right or on the left as mentioned above is possible when moving the avatar from a lower arrangement priority to a higher arrangement priority. In addition, by not judging right and left when the arrangement priority is changed from lower one to higher one, it is possible to prevent a specific avatar from being fixed on the right or left.

In this manner, by separating the priority of the scores created by the server from the arrangement priority of the avatars to display at the terminal allows creation of the chat software with higher flexibility.

FIG. 10 will now be described again.

Once the arrangement priority of each avatar is determined as described above, the avatar movement module 21 sends the arrangement priority of each avatar to the avatar customization display module 11. The avatar customization display module 11 redisplays the avatars with the arrangement priority determined at the step S333 (step S335). At the same time, the avatar movement module 21 creates drawing data for the speech balloon line (refer to FIG. 3) based on a relationship of the avatar with the speech balloon generated by the change of the position of the avatars in order to change the position of the already displayed speech balloon line corresponding to the avatar. The created drawing data for the speech balloon line is sent to the avatar customization display module 11, and the avatar customization display module 11 draws the speech balloon line (step S336).

In addition, in redisplaying the avatars at step S335, the avatars may be moved to new locations by animation. Moreover, the lines for the speech balloons at step S335 may also be moved in the same manner as the avatars.

As described above, changing the arrangement of the avatars after receiving the score allows an avatar with a higher priority to be displayed in a more noticeable position on the screen. In the present embodiment, the priorities of the avatars are scored by distinguishing old messages from new messages. Therefore, the avatar used by the operator who actively speaks will be arranged in a noticeable position at the avatar arrangement area 1001 (that is, the left end in FIG. 11 and the center in FIGS. 12 to 14). Thereby, the avatars which actively speak can be easily distinguished from the avatars which do not on the screen.

In addition, limiting the number of the avatars to be displayed, preventing the avatars with the score lower than a fixed score from being displayed, etc. are also included in the scope of the present invention.

Next, an operation of each terminal which has received the chat data sent from the server 100 at the step S312 shown in FIG. 6 will be described. The terminal which has received the chat data has to create a new speech balloon (step S315 in FIG. 6) and move existing speech balloons (step S316 in FIG. 6). Therefore, each process will be described separately.

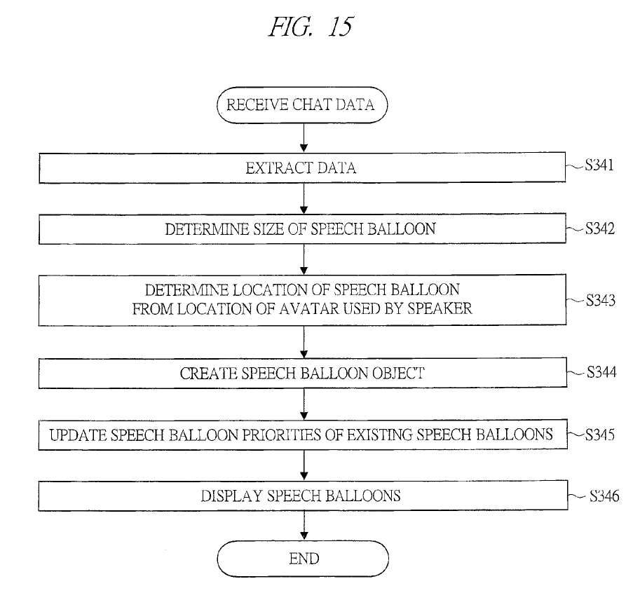

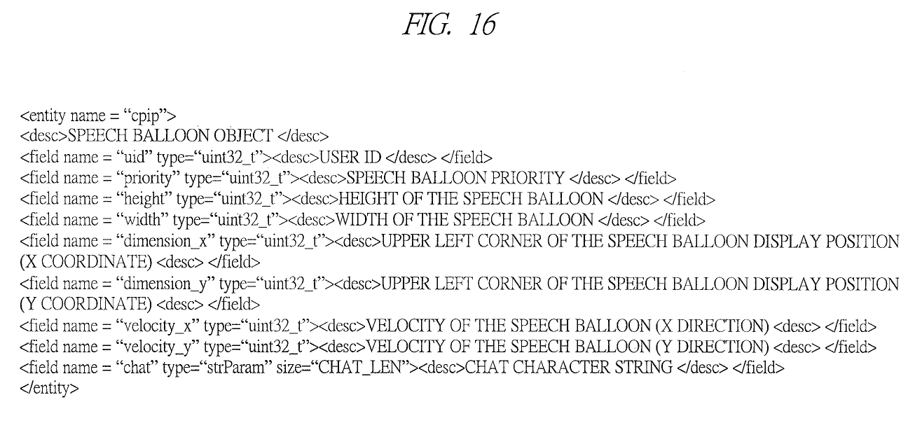

FIG. 15 is a flow chart showing the process to create a speech balloon.

First, when the terminal receives the chat data, the message frame movement module 22 extracts entity data for display from the received chat data (step S341). In the example of FIG. 7, “chat character string” is extracted from the chat data. At the same time, the type of the data is extracted (the “type” subparameter of the chat character string in FIG. 7).

Subsequently, the message frame movement module 22 calculates the size of the display area required for display with the entity data for display and the data type extracted at the step S341, and determines the size of the speech balloon so that the display area will be fit (step S342). In this process, the necessity of line feeds etc. is also checked in the case of text data.

Once the size of the speech balloon is determined, the message frame movement module 22 determines the position to display the speech balloon (step S343). That is, a relevant avatar is searched with the user ID shown in FIG. 7 and an initial position corresponding to the display position of the avatar is determined as a display position.

Once the display position is determined, the message frame movement module 22 refers to display data and data for the display area and the display position and creates a speech balloon object (step S344). The speech balloon objects here are a software-based concept for managing speech balloons and include data (the user ID, the display data, and data for the display area and the display position) described above and data for “speech balloon priority” indicating the priority of data. Collision detection etc. among the speech balloons to be described later will be performed per the speech balloon object.

The speech balloon priority data here determines a relation in overwriting speech balloons and sequence of determinations in collision judgment. In principle, newer data has a smaller value, and older data has a greater value. Note that, the initial value of the speech balloon priority data is 0.

FIG. 16 is a conceptual description showing a data configuration of the created speech balloon object written in the XML format. This speech balloon object consists of a user ID “uid,” a speech balloon priority “priority,” a height of the speech balloon “height,” a width of the speech balloon “width,” an upper left corner of the speech balloon display position (X coordinate) “dimension_x,” an upper left corner of the speech balloon display position (Y coordinate) “dimension_y,” a velocity of the speech balloon (X direction) “velocity_x,” a velocity of the speech balloon (Y direction) “velocity_y,” and a chat character string “chat.”

The user ID “uid” is a parameter for storing the user ID of the operator of the avatar as a speaker. After the speech balloon object is created, this value will not be changed until the object is deleted.

The speech balloon priority “priority” is a parameter indicating the priority which is set as 0 when the speech balloon is created. In the present embodiment, the speech balloon priority “priority” with a smaller value has a higher priority. However, depending on a design, the speech balloon priority “priority” with a greater value may be given a higher priority. Every time a new speech balloon object is created, the speech balloon priority “priority” of an existing speech balloon object is incremented by one.

The height of the speech balloon “height” is a parameter indicating the height (length in the Y direction) of the speech balloon to be displayed. The width of the speech balloon “width” is a parameter indicating the width (length in the X direction) of the speech balloon to be displayed.

The upper left corner of the speech balloon display position (X coordinate) “dimension_x” and the upper left corner of the speech balloon display position (Y coordinate) “dimension_y” are coordinates indicating the upper left position of the speech balloon used as the reference point to display the speech balloon.

The velocity of the speech balloon (X direction) “velocity_x” and the velocity of the speech balloon (Y direction) “velocity_y” are indexes indicating the movement vector of the speech balloon.

The chat character string “chat” is a character string to be displayed in the speech balloon.

Here, as well as the already described speech balloon priority data, the moving velocity of the speech balloon (velocity_x and velocity_y) used hereafter are given the initial values of 0. The height of the speech balloon and the width of the speech balloon are given the initial values calculated at the step S342. The upper left corner of the speech balloon display position (X coordinate) and the upper left corner of the speech balloon display position (Y coordinate) are given the initial values calculated at step the S343. The chat character string is given the entity data extracted at the step S341 as an initial value. The user ID of the chat data is used for the user ID of the speech balloon object without making any changes.

When a new speech balloon is created, the speech balloon priority of existing speech balloons has to be changed. Accordingly, the speech balloon priority “priority” of the existing speech balloon objects is increased by 1 (step S345).

In the description above, the speech balloon object is given a higher priority when the speech balloon priority “priority” is smaller. However, when the speech balloon object is given a higher priority when the speech balloon priority “priority” is greater, the process at the step S345 will be a subtraction process.

Subsequently, the message frame movement module 22 sends the data (the display data, and the data of the display area and the display position) described above to the message frame display module 12. The message frame display module 12 refers to the data to display a new speech balloon on the screen (step S346).

As described above, the terminal displays the new speech balloon 2000-new on the screen 51 of the display device 50.

Next, the collision judgment between the speech balloons and movement of the speech balloons in the case where a collision occurs will be described.

The collision judgment of the speech balloons is performed at a constant cycle or every time a new speech balloon is created.

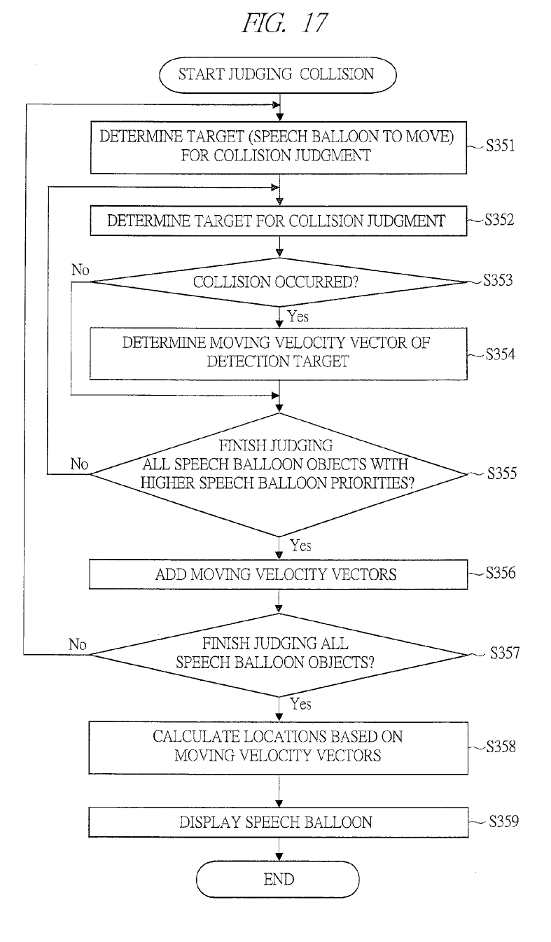

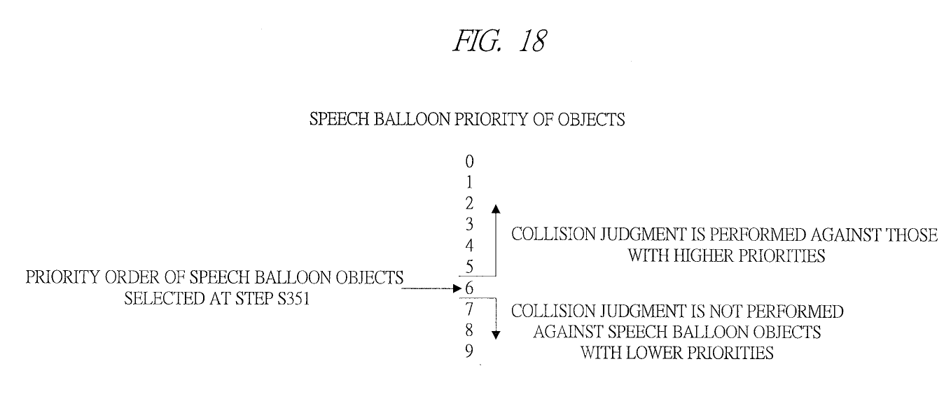

FIG. 17 is a flow chart showing the collision judgment process.

The message frame movement module 22 determines a speech balloon object for which the collision judgment will be performed (step S351). In this process, the new speech balloon 2000-new is not treated as an object to be moved. At first, the message frame movement module 22 performs the collision judgment of a speech balloon object having the speech balloon priority data of 1.

Subsequently, a speech balloon object having the priority data smaller (=priority is higher) than that of the speech balloon object determined at the step S351 is selected as a target for the collision judgment (step S352).

An occurrence of a collision between the speech balloon object selected at the step S351 and the speech balloon object selected at the step S352 is determined (step S353). The concrete determination method will be described below.

The speech balloon object selected at the step S351 will be referred to as a speech balloon A, and the speech balloon object selected at the step S352 will be referred to as a speech balloon B here.

As mentioned above, the speech balloon object has a record of the X coordinate and the Y coordinate of the upper left corner and the width and the height of the speech balloon. The X coordinate of the object A will be referred to as AX, the Y coordinate as AY, the width as AW, and the height as AH below. The X coordinate of the object B will be referred to as BX, the Y coordinate as BY, the width as BW, and the height as BH below.

The following expressions are provided as examples to be used for the collision judgment performed by a CPU of a terminal.

BX+BW−AX>0 Expression (1)

AX+AW−BX>0 Expression (2)

BY+BH−AY>0 Expression (3)

AY+AH−BY>0 Expression (4)

When all the above equations are satisfied, two speech balloons are overlapped. The two speech balloons are not overlapped when any one of the equations is not satisfied.

When a collision is determined to be occurred (step S353: Yes), a distance to move the speech balloon A is calculated (step S354).

When calculating the distance to move the speech balloon, the central point of the speech balloon is calculated.

The central point of the X coordinate of A: ACX=AX+AW/2 Expression (5)

The central point of the X coordinate of B: BCX=BX+BW/2 Expression (6)

When ACX is larger than BCX (ACX>BCX), a movement vector VX in the X direction is set to be BX+BW−AX. When ACX is smaller than BCX (ACX<BCX), VX is set to be BX+AX−AW. When the balloons are overlapped in the Y direction, VY=AH−BY.

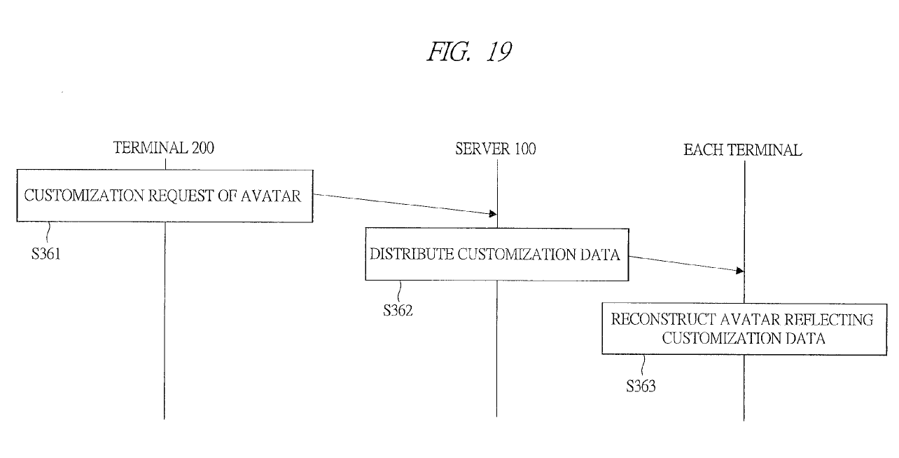

FIG. 18 is a conceptual diagram for understanding the step S352.

In FIG. 18, a speech balloon object having the speech balloon priority of 6 has been selected at the step S351. In this case, the collision judgment processes from the step S352 to the step S354 are performed for 6 times in total. In addition, the collision judgment is not performed to the speech balloon objects having the speech balloon priority of 7 or lower.

FIG. 17 will now be described again.

As for the speech balloon A, after the collision judgment is performed to all the speech balloon objects having the priority higher than that of the speech balloon A (step S355: Yes), the message frame movement module 22 adds all the determined moving velocity vectors (step S356). In this process, the moving velocity (velocity_x and velocity_y) inside the speech balloon object of the speech balloon A is also added.

Accordingly, calculation of the moving velocity vector of one speech balloon object is finished.

Subsequently, the same calculation is performed for all the speech balloons on the screen. When the above-mentioned calculation is completed for all the speech balloons (step S357: Yes), new locations for the speech balloons of the speech balloon objects are determined from the moving velocity vectors of all the speech balloon objects (step S358). The calculation could be performed in such a manner that the shorter the cycle of the collision judgment is, the smaller the influence of the movement vector is, and the longer the cycle is, the greater the influence of the movement vector is. Selection of a concrete calculation method depends on design.

Then, when the new locations of all the objects have been determined, data (the display data, and the data of the display area and the display position) is sent to the message frame display module 12. The message frame display module 12 refers to the data to display new speech balloons on the screen (step S359). When a speaker has left and the avatar relevant to the speech balloon to be displayed has disappeared, the speech balloon relevant to the avatar may be deleted.

Periodically repeating the collision judgment as described above allows the speech balloons on the chat screen to move like an animated cartoon.

Note that, the message frame movement module 22 deletes the created speech balloon objects when the speech balloon object reaches the top of the screen (the Y coordinate of the upper left corner of the speech balloon is 0 or smaller), when the speech balloon is scrolled out from the top of the screen, or when a fixed time period has passed after the creation of the speech balloon object.

A configuration such as above provides the screen of the chat software with more entertaining characteristics.

### Second Embodiment

A second embodiment of the present invention will be described hereafter.

Even in chat software, there is a case where a server manager wants to display a management message. In this case, according to the first embodiment, when the management message is scrolled in the same manner as the messages by normal users, the management message undesirably disappears from the top of the screen eventually.

In the second embodiment, there is provided a method for providing a higher priority to messages by the manager for display.

At the step S345 shown in FIG. 15 according to the first embodiment, the speech balloon priority is always incremented by one.

As opposed to this, in the present embodiment, a user ID of a speech balloon object is checked before the step S345. If the user ID of the speech balloon object is a manager's user ID which has been set in the chat software in advance, the speech balloon priority is left to be 0 without incrementing by one. Then, the message frame movement module 22 sets the speech balloon priority data of the newly created speech balloon object to 1.

This process allows manager's messages to be always displayed on the screen.

### Third Embodiment

Hereinafter, a third embodiment of the present invention will be described.

If an operator is able to properly make changes to whose avatar on a screen, entertaining characteristics of a chat screen will be further improved.

FIG. 19 is a flow chart according to the third embodiment (at the time of customizing appearance of an avatar) of the present invention.

A terminal of the operator who requests customization of his or her avatar sends an appearance change request to a server (step S361). The appearance change request sent here includes data to identify each parts of the avatar.

The server 100 which received customization data distributes the received appearance change request to each terminal (step S362).

The appearance change request is sent to the avatar customization display module 11 via an arithmetic module 20 of each terminal which received the customization request. After judging the contents of the customization, the avatar customization display module 11 reconstructs characters of the avatar with graphic part data 31 of the avatar (step S363)

Since the data is guaranteed to be the latest at the step S304 of FIG. 5, re-requesting is not necessary except the case where a transmission error is generated.

In this process, whether immediately updating the display on a screen 51 of a display device 50 with the constructed avatar or waiting for the step S335 of FIG. 10 to update the avatar depends on design.

According to the above-described manner, the operator can properly update the appearance of his or her avatar, and the chat software can be provided with more entertaining characteristics.

### Fourth Embodiment

Hereinafter, a fourth embodiment of the present invention will be described.

In the above-described embodiments, positions of avatars are simply changed by changing the order. On the other hand, in the present embodiment, the avatars are moved by animation according to a lapse time. Thereby, more entertaining characteristics are provided.

More particularly, a method of using objects for management of the avatars at an avatar movement module 21 to manage gradually changing situations.

A data configuration of the object used for avatar management at the avatar movement module 21 will be now described.

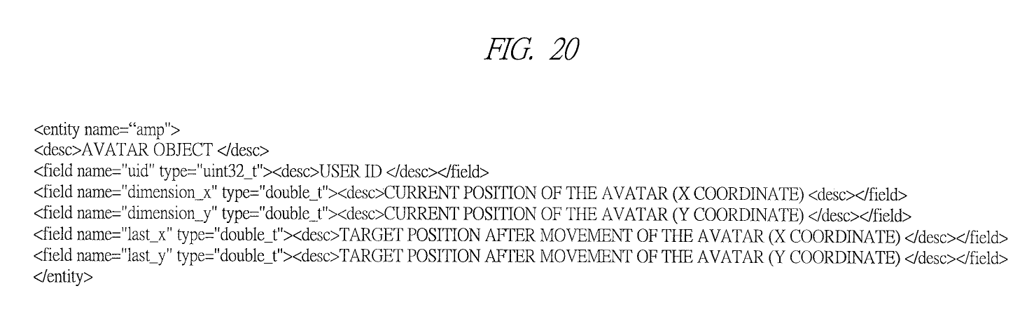

FIG. 20 is a conceptual description showing the data configuration of the object (object to manage the avatar) in the XML format used for avatar management according to the present embodiment. The avatar movement module 21 creates and starts managing this object to manage the avatar when a user ID which is not managed by the chat software which is currently in operation has been sent from a server 100. In addition, this object is deleted when the relevant user ID in the score sent from the server 100 no longer exists.

The user ID “uid” is an ID for identifying the operator of the avatar.

A current position of the avatar (X coordinate) and the current position of the avatar (Y coordinate) are parameters indicating the current position of the avatar. These parameters store parameters indicating the display position on the screen.

A target position after movement of the avatar (X coordinate) and the target position after movement of the avatar (Y coordinate) are parameters indicating the coordinate of the destination of the avatar.

Note that, while the Y coordinate is included herein so that the avatar arrangement area 1001 could include two or more layers, the Y coordinate may be omitted if the avatar arrangement area 1001 always includes only one layer.

In the description of the present embodiment, moving velocity or acceleration of the avatar is not managed by the avatar object. However, when the moving velocity or acceleration is changed with time, parameters to manage the moving velocity or acceleration may be added.

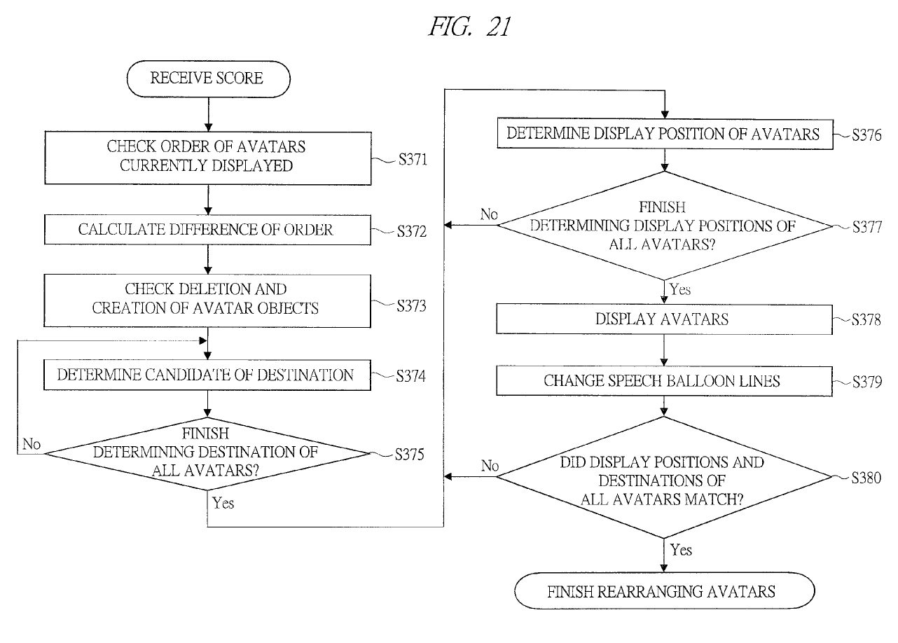

Next, management of the avatar module and display of the avatar will be described with reference to FIG. 21. FIG. 21 is a flow chart showing rearrangement after the terminal received scores according to the fourth embodiment, and corresponds to FIG. 10 in the first embodiment. Therefore, descriptions of the same processes as those shown in FIG. 10 will be only briefly described.

When the avatar movement module 21 receives the score, the avatar movement module 21 checks the order of the avatars currently displayed (step S371). Then, the avatar movement module 21 compares the order with the priority of the received score to check changes (step S372). These steps are performed in the same manner as in the steps S331 and S332.

Thereby, existing objects relating to user IDs not indicated in the newly received score and user IDs not relating to the existing object included in the score can be identified. Therefore, the objects relating to the user IDs no longer included in the score are deleted, and avatar objects relating to the new user IDs will be newly created (step S373). Then, a destination of each avatar is determined (step S374). In this process, as for the object other than those newly created at the step S373 (=existing objects), the coordinate etc. of the destination is indicated in the current position of the avatar (X coordinate) and the current position of the avatar (Y coordinate) of the avatar object. On the other hand, as for the avatar object newly created at the step S373, the initial display position of the avatar is inputted to the current position of the avatar (X coordinate) and the current position of the avatar (Y coordinate) as well as the target position after movement of the avatar (X coordinate) and the target position after movement of the avatar (Y coordinate).

The process of the step S374 is performed for all the avatar objects. When the destinations of all the avatar objects are determined (step S375: Yes), the position of the avatar to be displayed with the next drawing frame is determined (step S376). The display position of the next drawing frame is determined by performing “addition or subtraction” to the current position of the avatar (X coordinate) to approach the target position after movement of the avatar (X coordinate) when the values of the current position of the avatar (X coordinate) and the target position after movement of the avatar (X coordinate) are different. The same process is also performed for the Y coordinate. The value to “add or subtract” to the current position of the avatar (X coordinate), and whether the value to “add or subtract” is constant or dynamically changed depend on design.

When the display positions of all the avatar objects are determined (step S377: Yes), the avatar movement module 21 sends the current position of the avatar (X coordinate) and the current position of the avatar (Y coordinate) to the avatar customization display module 11. The avatar customization display module 11 receives the sent data and changes the display of the avatars and the speech balloon lines when the next frame is drawn (step S378, step S379). This process corresponds to the step S335 and step S336 shown in FIG. 10.

When the current position of the avatar (X coordinate) and the target position after movement of the avatar (X coordinate) as well as the current position of the avatar (Y coordinate) and the target position after movement of the avatar (Y coordinate) of all the avatar objects match (step S380: Yes), the rearrangement process of the avatars is finished. When no match occurs (step S380: No), determination of the display positions of the avatars, display of the avatars, and the process of changing the speech balloon lines are repeated until a match occurs.

In the manner described above, the display positions of the avatars can be dynamically changed. Thereby, the chat software is provided with more entertaining characteristics.

Note that, to complete the processes shown in FIG. 21, a certain period of time may need to be elapsed. A new score could be sent from the server 100 in this period. In that case, the process may be interrupted to start over from the process of step S371 again.

In the foregoing, the invention made by the inventors of the present invention has been concretely described based on the embodiments. However, it is needless to say that the present invention is not limited to the foregoing embodiments and various modifications and alterations can be made within the scope of the present invention.

As is already mentioned, the present invention is applicable to not only chat software, but also software involving many participants such as MMORPG (Massively Multiplayer Online Role-Playing Game) and moving picture service.

What is claimed is:

1. Chat software comprising a display module and an arithmetic module, and displaying a participant in a chat room established by a server connected via a communication module as an avatar, wherein
the communication module receives a score sent by the server;
the arithmetic module determines a display position of the participant in the chat room based on the score received by the communication module; and
the display module outputs the avatar to a connected display device based on the display position.

2. The chat software according to claim 1, wherein,
when chat data including a user ID of a speaker and text data of a message are sent from the server,
the communication module receives the chat data;
the arithmetic module creates, with regards to the chat data received by the communication module, a speech balloon object including information on the display position, the user ID of the chat data, and a speech balloon priority for determining an order among a plurality of speech balloons; and
the display module outputs a speech balloon with regards to the speech balloon object to the display device based on the information on the display position stored in the speech balloon object.

3. The chat software according to claim 2, wherein,
when a plurality of the speech balloon objects exist, the arithmetic module performs collision judgment of the speech balloons and updates the information on the display positions stored in the plurality of speech balloon objects; and
the display module outputs the speech balloons of the plurality of speech balloon objects to the display device based on the information on the display positions after update.

4. The chat software according to claim 3, wherein,
when the plurality of speech balloon objects are present, the arithmetic module updates only the information on the display position of a speech balloon object having a lower speech balloon priority when performing the collision judgment among the speech balloons.

5. The chat software according to claim 2, wherein
the speech balloon object having a smaller value of the speech balloon priority has a higher speech balloon priority.

6. The chat software according to claim 5, wherein,
when the communication module receives the chat data, the arithmetic module increments the value of the speech balloon priority of the existing speech balloon object by one.

7. The chat software according to claim 2, wherein
the speech balloon object having a greater value of the speech balloon priority has a higher speech balloon priority.

8. The chat software according to claim 7, wherein,
when the communication module receives the chat data, the arithmetic module decrements the value of the speech balloon priority of the existing speech balloon object by one.

9. Chat software comprising a display module and an arithmetic module, displaying a participant in a chat room established by a server connected via a communication module as an avatar, and managing a current display position and a target position after movement of the avatar by an avatar object corresponding to the avatar, wherein
the communication module receives a score sent by the server;
the arithmetic module determines the target position after movement of the avatar of the participant in the chat room based on the score received by the communication module, and records the target position after movement determined for the avatar object corresponding to the avatar;
when the current display position and the target position after movement of the avatar object corresponding to the avatar are different, the arithmetic module calculates an updated display position and records the calculated updated display position as a current display position of the corresponding avatar object; and
the display module outputs the avatar to a connected display device based on the updated display position.

10. The chat software according to claim 9, wherein,
when chat data including a user ID of a speaker and text data of a message are sent from the server,
the communication module receives the chat data;
the arithmetic module creates a speech balloon object including information on the display position, a user ID of the chat data, and a speech balloon priority for determining an order among a plurality of speech balloons with regards to the chat data received by the communication module; and
the display module outputs a speech balloon with regards to the speech balloon object to the display device based on the information on the display position stored in the speech balloon object.

11. The chat software according to claim 10, wherein
the avatar object further stores a user ID;
the user ID of the speech balloon object and the user ID of the avatar object are compared, and when the user ID of the speech balloon object is the same as the user ID of the avatar object, the arithmetic module creates drawing data for a speech balloon line for drawing a speech balloon line between the avatar corresponding to the avatar object and the speech balloon corresponding to the speech balloon object;
the arithmetic module sends the drawing data for the speech balloon line to the display module; and
the display module outputs the speech balloon line to the connected display device based on the drawing data for the speech balloon line.
